(19) United States
(12) Patent Application Publication
(10) Pub. No.: US 2024/0316486 A1
(43) Pub. Date: Sep. 26, 2024

(54) DEVICE AND METHOD FOR ENHANCED FILTRATION FOR BAKERY DUST AND DRIED GLAZE COATING

(71) Applicant: Norman G. Schmidt, Burnaby (CA)

(72) Inventor: Norman G. Schmidt, Burnaby (CA)

(21) Appl. No.: 18/585,048

(22) Filed: Feb. 22, 2024

Related U.S. Application Data
(60) Provisional application No. 63/447,603, filed on Feb. 22, 2023.

(51) Int. Cl. B01D 46/04; B01D 46/44; B01D 46/48; B01D 46/71; B01D 46/76

(52) U.S. Cl. CPC B01D 46/04; B01D 46/44; B01D 46/48; B01D 46/71; B01D 46/76; B01D 2265/06; B01D 2271/027; B01D 2273/30

(57) ABSTRACT

An embodiment is designed for and provided in a large commercial bakery setting which can typically make roll products such as but not limited to hamburger buns to filter air from a cleaning process. The invention can include for example one or more cage elements with a filter material that during operations takes a pleated shape upon the cage elements so as to filter particulate from the air. During a regenerative process the filter media is retained in such a way that it can easily reverse the pleats and force the removal of any compacted filtrate or debris from the pleats and any adhered materials on the filter media. The re-released materials are further collected in a fashion similar to the filtered material in a collection area below the filter assemblies. The invention entails the removal of these contaminants and their excess from pans and the like and filtration of the air and area around the cleaning of the pans from these particulates. Finally, a process employing a more efficient filtration system, providing a regenerative cycle, with a separated assembly divided design maximizing surface area for filtration and modulating the air to remove debris through the chamber separation and to spread air flows, and providing easy access for cleaning and maintenance of the filtration media is described.

### CROSS-REFERENCE TO RELATED APPLICATIONS

This application claims the priority of U.S. provisional patent application No. 63/447,603, filed Feb. 22, 2023, which is incorporated herein by reference.

### BACKGROUND OF THE INVENTION

### Field of the Invention

The invention relates to dust collection and extraction, in particular to an improved device for collecting fine particulates in an industrial process, removing the particulates and providing for a regenerative cycle to extend time between shutdown and maintenance of filter media and cleaning. More specifically, this relates to dust and debris removal in commercial bakery production and systems wherein the removal of flour dust, seeds, flakes of glaze protein wash and the like is typically generated in such processes. The invention entails the removal of these contaminants and their excess from pans and the like and filtration of the air and area around the cleaning of the pans from these particulates. Finally, a more efficient filtration system, providing a regenerative cycle, a design maximizing surface area for filtration, chamber separation to spread air flows, and easy access for cleaning and maintenance of the filtration media is provided.

### BACKGROUND OF THE INVENTION

In existing prior art filtration systems in the baking industry there exists filters that typically us a filtration media such as but not limited to fitted cloth sock-like “bag” which have a degree of porosity to let air thru and hold particulates and dust on the surface or pass into the cloth to be held there. These bags had reasonable results but often the bags could not hold the required amount of commercial baking dust and at some points the dust would tend to come thru the filter medium either by design to force quicker replacement and greater sales of the bags or just as a design requirement due to operating space or conditions. Cleaning of these bags was often done by introducing high pressure pulses of compressed air to the discharge side of the filter—basically blowing high pressure air on or at them-which would to a degree dislodge the dust and allow it to fall from the outside or input side of the filter medium. These bags are typically arranged in a higher numbers of smaller cylinders so as to maximize the amount of dust collecting surfaces for a given filter box volume. One issue with cleaning in this fashion however, given this arrangement, when the pulse of hi pressure air would react to blow the dust on a first bag or cylindrical sleeve of filter material it would pulse the blown off debris and dust would to an adjacent cylindrical sleeve or filter bag and deposit on and/or in the adjacent filters thereby reducing the filtering ability of the adjacent filters. This is less than efficient and simply blowing air across or on one set of tubes does not clean the set. Thus, to do a full cleaning of the cylindrical sleeves or filter bags or tubes, the filtration cloths the media must be removed and cleaned in a water wash typically via a laundry service provider, for example. Where they would come back substantially clean and free of filtered materials but this requires significant additional maintenance time and costs. Thus a need exists for and a significant advantage can be found by extending the life of the bags and increasing efficiency and convenience of the filter system by improving the designs.

In an attempt to improve efficiency and speed filter replacement, another existing filtration system and method was developed with the introduction of cartridge filters that had a substantial amount of surface due to the pleated use of a fibrous or cellulose filter element medium. When new or put into operation these filters tend to do a good job, the pleats provide significant benefit in area applied for filtration. But there are design factors that drop this positive filtration aspect and make the system equally or more inefficient as well as wasteful and increasing impact to the environment by creating spent filter waste. For instance, once the dust enters the filter medium it does not release and go out easily, it ends up being tightly held. The pleated configuration of the medium tends to allow dust and particulate materials to enter into and proceed down and into the tight folded or v-shaped wedging areas of the pleat where the sides of the pleat go tighter and tighter together, here in the tight areas or vertices of the pleat the dust and debris materials are mechanically held. In addition when an air blast intended to clean out these pleats occurs it does not yield significant cleaning as the materials in the sharp vertices do to the compaction or wedging of the material in the v-shaped portion of the pleat, this compacted material does not tend to come out.

Additionally, although these filters are stated or described as washable they tend not to clean out very well. It is the case that these filters contain highly pleated material where access to cleaning in the depths of these pleats, the v-shaped wedge area where the surfaces come together, is difficult to access as well as remove material. As previously stated the shape of the pleat vertices offers greater resistance to cleaning due to compaction, where wedging from the sides these pleat vertices become a place where larger debris becomes lodged and they mechanically bond to the surface of the pleat or filter medium under pressure. Once these larger pieces of debris become lodged they tend to collect and protect the finer particles held below the outer layer of large debris. Even when a pulse or reverse air pressure is applied, the pleats in these cartridges are typically rigid and cannot be opened or easily reverse to promote release of these materials.

Additionally, with the lack of the ability to release the filter media from the fixed filter canister structure, there is no way to properly launder via for example a wetted cloth cleaning process as the media is not releasable as in the cloth bag prior art devices. In particular, in the case of commercial baking arrangements, due to the nature of the materials when you wet the cartridge element without fully removing the dust and debris materials which often contain the flour and glaze materials which are intended to be applied to the surface of the bun but was deposited to the surrounding sheet metal of the bun pan then removed after the baking process, when this flour dust is not fully removed and then gets wetted as in a washing process it literally creates paste and the glaze material when wetted becomes like a varnish or surface sealer. Combined, these materials tend to seal off the surface of the cartridge filter, greatly reducing the filtration effect after washing and drying. Only a thorough washing of a separated and loosened media would be able to remove this material and filter cartridges do not provide such capability. The result being the best way to clean the cartridge is to discard and replace it. This increases waste and operating costs and has a negative environmental impact.

Ideally, a need exists in the food product industry for a filtering device where a bag style filter or a cartridge filter media are provided in a configuration maximizing filtration while providing easy maintenance of the device. Such a device would include providing an ability to use controlled air blasts efficiently so as to clean off filter surfaces that can have accumulated a build up of filtered material/dust/debris in a dry fashion, avoiding the issue with creating paste and varnish. A non-limiting example can include a dust collector that will draw air thru a bag so as to remove dust and debris. This surface is where materials go to and stay on the surface of the bag as the air passes thru the bag. Over time the surface of the bag can become packed or coated with dust and or debris, which decreases the ability of the filter media of the bag to remove said debris. A desired objective is to clear the dust and/or debris from the filter bag surface so as to regenerate the media and provide improved dust and or debris removal efficiency or bring it back to a higher efficiency while providing quick, easy access to debris removal and cleaning capabilities.

In such a device, an exemplary design would include mechanical agitating elements and oscillating devices to provide the bag movement, including for instant but not limited to reversing shapes or direction in the filter media and/or a pulsed flapping or motion, during regenerations such as but not limited to an air blast that that can cause the bag to move in such a manner that it will motivate, re-release the dust and debris commonly being filtered from the air drawn in industrial environments in the filter material and off and away from such material. This agitation is propagated or created in a manner that will provide the greatest amount of mechanical action to shake, snap or cause the debris to re-release and fall from the filter medium surface. The mechanism and process of applying an air blast which typically gives a shock or pulse to the filter medium to help motivate or loosen the debris from the filter material can for instance but is certainly not limited to being assisted by the simultaneous significant air flow passing in the reverse or opposite of normal direction to help carry or remove the dust and debris which can be adhering to the surface of the filter bag or filtration media. Additionally at least one cage structure can be incorporated to aid in retention of the filter media whilst providing directed and enhanced airflow, shaping of the filter material, and containment of debris during both operation and regeneration operations.

This can include non-limiting exemplary embodiments where there can be at least one cage and at least one bag or filter media that has anchor points on the bag or filter media surface that can attach the filter media with excess material viz-a-vis the surface are of the cage, e.g. the material is oversized and provides additional filter media to be moved during operation. Thus creating a system where filter media is suspended in such a way as to provide significantly more filter surface area as well as a way to snap or create a mechanical action to reverse movement, preferably in a rapid movement or pulse, that opens or flexes the filtration medium position to a reversed position releasing accumulated debris and dividers between the filter units to direct back wash or material and dust and debris released during regenerative cycles down and away towards a collection area rather than blow it from one filter to the side and onto other filters.

### SUMMARY OF THE INVENTION

An aspect of the invention is to provide an air filtration system having the convenience and ease of maintenance of existing cloth filter media systems, the increased surface area and efficiency of pleated cartridge systems, the extended operating cycle of a system having a regenerative air pulse system and the ability to provide the reversibility of the filter media held in a pleated fashion within a filter assembly in a first direction and reversing the first direction to a second direction, opposite the first and in such a way so as to dislodge any wedged materials.

Another aspect of the invention is to provide a system having a structure sufficient to isolate and divide the airflow of each filter assembly cage from the other and thereby prevent re-released particulate shed during a regenerative cycle from entering and accumulating in other assemblies.

Yet a further aspect of the instant invention is to provide a filter assembly cage having an inner cage component facilitating a pleated media shape during operation and that allows for reversal of the media direction to regenerate and re-release compacted particulate.

An aspect of the invention includes a filter assembly cage having an inner and an outer cage component, media coupling and attachment points thereon, with the media contained between the cage components to form pleats in a first direction on the inner cage component and a second, opposite direction upon the outer cage during a regeneration cycle.

A still further aspect of the invention is to provide a mechanism and method to extend the useful life of the filter media, in particular to provide a cloth filter media or washable cartridges with additional time in service between cleanings or extend the useful life of replaceable filters.

The invention includes a method, an apparatus, and an article of manufacture for filtering air of particulate. The invention includes an article of manufacture, an apparatus, a method for making the article, and a method for using the article.

The apparatus of the invention includes a commercial baking air filtration system coupled to a commercial baking apparatus, the system providing an external frame forming at least one chamber with an at least one suction or blower device, the suction or blower device creating at least two directions of air flow within the commercial baking air filtration system during operation. An at least one controller controls the at least one suction or blower device to operate to draw air in the at least two directions of air flow. An at least one filter assembly is provided with an at least two filter cages having one or more filter support members, the first of the at least two cages surrounding and being spaced apart from the second of the at least two filter cages. An at least one filter medium covers the second of the at least two filter cages and is adapted to surround the second cage with sufficient filter material to allow the least one filter medium to deflect around the one or more filter support members in a first of an at least two directions of air flow and reverse direction away from the second of the at least two support cages and deflect around and into the first of the at least two filter cages between the one or more support members in a second of an at least two directions of airflow. And an at least one collection area collects debris from the filtration of the air circulated from the baking apparatus and filtered by the commercial baking air filtration system.

The first direction of airflow of the at least two directions of airflow can be provided during a normal operation mode of the commercial baking air filtration system drawing in and filtering air from the baking apparatus. The second direction of airflow of the at least two directions of airflow can be provided during a regeneration cycle operation mode of the commercial baking air filtration system blowing air back into the commercial baking air filtration.

The controller can be adapted to operate the blower in said regenerative cycle operation mode to reverse the direction of the at least one filter media around the one or more support members of the first cage member of the at least two cage members and reduce pressure to flex or flap the at least one filter media to withdraw from at least in part from around the one or more support members and then reapply pressure to again fully reverse the direction of the filter media surround the one or more support members.

The one or more support members can be arranged in the at least two cage members so that the at least one filter media is drawn in to form an at least one v-shaped pleat around the one or more support members of the at least two cage members in both of the at least two directions of airflow. The at least one pleat is formed in the direction of the first direction of the at least two directions of airflow in a normal operation mode. The at least one pleat is formed in the direction of the second direction of the at least two directions of airflow in a regenerative cycle operation mode.

The at least one controller can be adapted during the regenerative cycle operation mode to rapidly change or pulse pressure in the commercial baking filtration system and thereby create a flapping motion in the at least one filter material as between the two different directions of the at least one pleat, the flapping motion discharging debris captured in the at least one filter media. The at least one filter media can be bag shaped and adapted to fit over the first of the at least two cage. The at least one filter media is at least one of a cloth, paper, mesh, pre-pleated cloth, pre-pleated paper, and pre-pleated mesh. The at least one chamber can further include multiple chambers for each of the at least one filter assembly.

The system can also include an at least one filter collar on said at least one filter assembly, the at least one filter collar detachably retaining said at least one filter media during operation of the system. The at least one filter assembly can further comprise a cage formed from the first and second of the at least two cage members, a clamping surface, a cage assembly clamping disc, a cage stiffening ring secured to the second of the at least to cage components, a cage retaining device, a further cage retaining device, and a cage gasket collectively coupling the first and second of the at least two cage members to form the cage.

The apparatus of the instant invention further includes a commercial baking air filtration system coupled to a commercial baking apparatus, the system having an external frame forming at least one chamber with an at least one suction or blower device, the suction or blower device creating at least one direction of air flow within the commercial baking air filtration system during operation. An at least one controller controlling the at least one suction or blower device to operate to draw air in the at least two directions of air flow with one or more filter assemblies. The filter assemblies having an at least one filter cage having one or more filter support members with an at least one filter medium covering the at least one filter cage adapted to surround the at least one cage member with sufficient filter material to allow the least one filter medium to deflect around the filter support members in a first of an at least two directions of air flow and reverse direction away from the support members in a second of an at least two directions of airflow. And an at least one collection area collecting debris from the filtration of air circulated from the baking apparatus and filtered by the commercial baking air filtration system.

An at least one pleat can be formed in the direction of the first direction of the at least two directions of airflow in a normal operation mode. The at least one controller can be adapted during the regenerative cycle operation mode to quickly change or pulse pressure in the commercial baking filtration system and thereby create a flapping motion in the at least one filter material as between the direction of the pleat and the second direction of the at least two directions of airflow, the flapping motion discharging debris captured in the at least one filter media. The at least one filter media can be bag shaped and adapted to form pleats about said at least one cage member and the one or more support members in the first of the at least to airflow directions and expand into a billowing bag shape that flaps in the second of the at least two airflow directions.

The invention includes a method of operating a commercial baking air filtration system, the method comprising: drawing in air from a commercial baking environment in an operating mode, said air having filterable debris; passing the air in through an at least one frame having at least one filter chamber with at least one filter assembly, the at least one assembly having an at least one filter media; drawing the at least one filter media over an at least one filter cage having one or more filter supports located in the at least one filter chamber; filtering and collecting debris within the at least one filter media and the at least one filter chamber; detecting when the operating efficiency of said at least one filter media is degraded from the filtering and collecting of debris; initiating a regenerative cycle wherein the air being drawn in is reversed in direction and blown back into the filter chamber and the at least one filter media is reversed away from said at least one filter cage and one or more filter supports; varying the pressure of the air reversed during the regenerative cycle to impart a flapping motion in said at least one filter media and thereby releasing the debris collected in the at least one filter media; and collecting and disposing of the debris contained within the at least one filter chamber.

The method can further include the step of collecting and disposing the debris further comprises operating a door to release the collected debris from the at least one filter chamber. Further, during the step of initiating a regenerative cycle and the reversal of the air the method can further include the step of engaging a further at least one outer cage with the filter media and the step of varying the pressure further flexes the at least one filter media around one or more cage supports in the at least one out cage to impart the flapping motion.

Moreover, the above objects and advantages of the invention are illustrative, and not exhaustive, of those which can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

Embodiments of the invention are explained in greater detail by way of the drawings, where the same reference numerals refer to the same features.

FIG. 1 shows an exploded view of a non-limiting exemplary embodiment of the instant invention, including inner and outer cage components and a filter media.

FIG. 2 shows an assembled view of the exemplary embodiment, having the inner and outer cage components with the filter media disposed there between and spaced so as to allow the requisite movements.

FIGS. 3 and 4 show the embodiment of FIG. 1 under vacuum, suction forming the media around the inner cage component.

FIGS. 5 and 6 show the embodiment of FIG. 1 during a regenerative cycle reversing the air flow and pulsing the air within the chamber whereby the media is reversed and forms around the outer cage component.

FIGS. 7 and 8 show a further embodiment having an inner cage component but lacking the outer cage and having a bag like media component.

FIGS. 9 and 10 show cutaway views of an embodiment of the instant invention having multiple divided compartments.

### DETAILED DESCRIPTION OF THE INVENTION

Non-limiting exemplary embodiments of the instant invention are shown and designed for and provided in a large commercial bakery setting which can typically make bread roll and similar products such as but not limited to hamburger buns. In the manufacture of the roll products or buns, the buns will typically receive and be exposed to many types of coatings, such as but not limited to a flour coating to keep portioned dough from sticking to working process surfaces, then seeds can also be applied as well as a glaze which provides a sheen to the surface of the bun and additional possible coatings generally sprayed or aerosolized for application. The application of these materials is not only confined to the surface of the bun but certain amounts of these materials are not properly attached to the bakery product or bun. The excess or overspray deposits on the pan and then gets baked such that must be removed in a pan cleaning operation.

Typically this requires mechanical agitation to remove the baked on, flaked on, over sprayed material in a pan cleaning system or operation. This releases this material into the air, so then these particles must be removed from the air used in and around the pan cleaning operation. This filtration process requires a mechanism to remove the material from the air as well as a mechanism to reverse discharge the dust and particulates from the air to maintain cleanliness and meet sanitary requirements for the filer mechanism. The air used in the process is circulated to filtration for the removal of debris such as flour dust, sesame seeds and excess glazing materials that dry and the debris components that are removed from pans needs to have these materials removed from the air stream that they are contained in.

This invention will take a commercially available filtration media and deploy it in such a way that the amount and surface area of filtration media is significantly increased so as to provide greater surface area whilst deployed and increased ability to filter. In addition, the exemplary embodiment of the instant invention provides a better way to remove this filtered out debris from the filtration media thru a regenerative process so as to clean the filter media and extend its useful life as well as meet sanitary operating requirements without required downtime for deinstallation and/or further cleaning of the media to maintain efficiency.

The invention is intended to provide a way to use the cleanability/washability of the cloth filter medium but also create a means of utilizing it in a manner that will increase the usable surface area on par with pleated filter media as well as have it where a regeneration cycle using a pulse of compressed air can better clear dust and materials from the filter medium surface in between cleanings as well as not have or reduce these re-released filtrate materials of dust and debris move or deposit onto adjacent filters which reduces the filtering ability of neighboring filters.

Ideally the movement would be to have a degree of mechanical action where the bag would go thru a large amount of movement and the movement would be significant enough to cause a flapping effect where the bag or material has momentum from the movement plus air flow movement sufficient to cause the filtrate materials (flour dust, seeds, glaze flakes and the like) to break loose from adhering to the surfaces and the reverse airflow would motivate these filtrate materials to continue to move either off as in the case of larger materials and/or thru for small particulates such as but not limited to flour dust where the particles get filtered out by the finer weave and then become lodge into the filter medium and motivated out to a collection area.

If the air flow is only reversed in direction then some of the particles will become dislodged and if one uses a blast of reverse direction air then it can break some of these fine particles loose but if in turn these particles go up against an opening in the filter material then the dust particle can become lodged in and not able to come back out so as to be removed from the filter material. Ideally in the exemplary embodiment the movement of the material of the filter material at the same time as the application of the reverse flow air is applied so that dust and materials have a passage way that is opening to become a passage way of increasing size to better motivate the particle to follow through this passage way out of the filter medium. This would be particularly important when the filter media is structured into a peak and valley type of configuration, where the aforementioned caking can occur in the valleys during operation.

As a simple example if you have a rug and it is subjected to a gradient of materials such as fine sand and or particles, fibrous materials such leaves, dog or cat fur. When the rug is in a normal operating position gravity plus mechanical movement from being walked upon will provide paths for the debris to go down deeper into the rug. When one wishes to clean this rug one tends to hang it and beat it so that the combination of impact to the rug will tend to dislodge particulates and, specifically, the movement will open or flex the rug material so that the particulates can follow this passage way and discharge. This has worked for generations but a way to make this the best possible is to add or create differential air pressure where air flow is going thru the rug in the direction of how we are trying to motivate the debris out of the rug. The air having among other benefits will just tend to fluidize the debris in that the air is lifting and passing the particulate thru the passages that are opening due to the flexing of the rug.

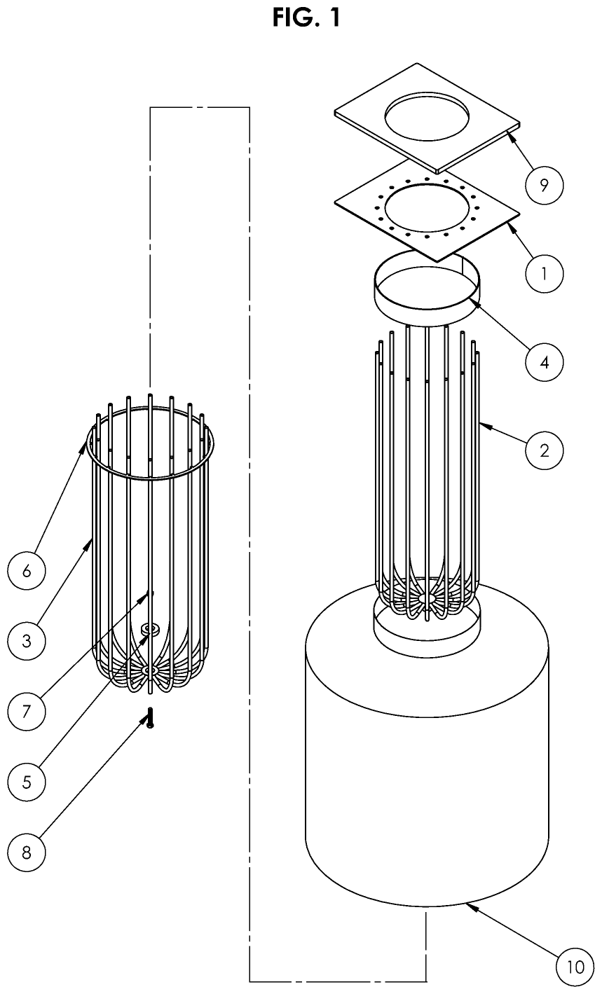

FIG. 1 shows an exploded view of a non-limiting exemplary embodiment of the instant invention, including inner and outer cage components and a filter media. A filter and a retention system are shown in the figures. The bag or filter media 10 is provided. A bag style filter media is shown as a non-limiting example, though a pre pleated paper or similar filter could be equally used. As in FIGS. 1 thru 10 where the filter media 10 is retained in between an inner cage component or bag cage 2 and outer cage component or bag cage 3, where said filter bag or media 10 is placed between these components and retained there between during operations. Each cage having bars or slats and additional structural components and being selectively detachable so as to permit removal of the bag during servicing. And where this filter media 10, which as noted can also be either a filter, a sleeve, a bag or similar configuration, but having or being of a size significantly greater than the diameters of the constraining cages so as to contract therein in one flow direction and be constrained by the inner bag component 2 and to expand thereabout and be constrained by the outer component 3 in another direction of airflow.

This configuration as shown FIG. 1 is visually similar to what appears to be an old style bird cage within another cage, being both on the inside and outside of the filter bag, sleeve, membranes, or media which is confined to the area between both the inner and outer cage components 2, 3. FIG. 1 shows the inner cage component 2, outer cage component 3 each component having additional vertical (as shown) and optionally horizontal cross members (not shown), an inner cage clamping surface 4, cage assembly clamping disc 5, outer cage stiffening ring 6 which is secured to outer cage component 3, cage retaining device 7, a further cage retaining device 8, cage gasket 9, and the filtration media or bag 10 all of which comprises a filtration cage assembly 11. As shown the bag or filter media 10 is coupled to inner cage component 2 by the clamping disc and the retaining devices 7,8 which couple the filter media 10 between the inner cage component 2 and the outer cage component 3. The filter media 10 is run up along the inner cage component 2 and retained at or near the opposed end of the cage components 2, 3 held clamped in place between the inner clamping surface 4 and the outer cage component 3 and its reinforcement 6.

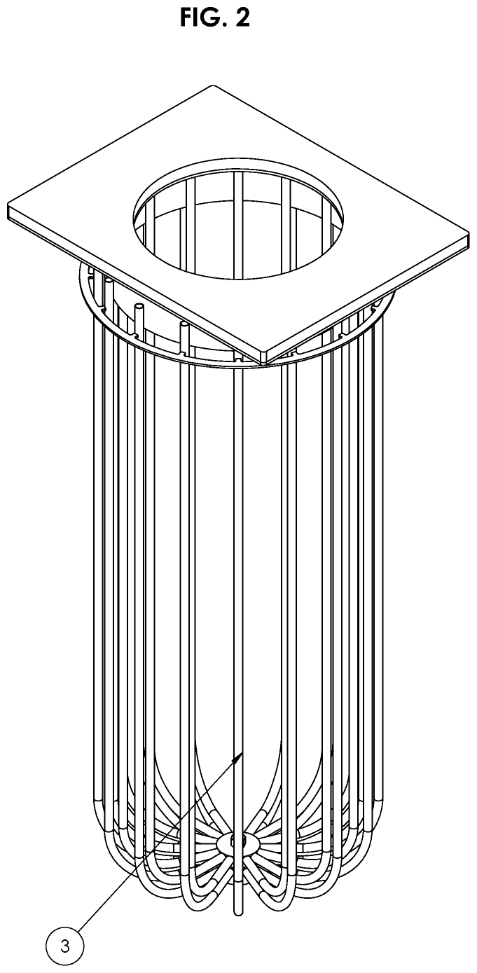

FIG. 2 shows an assembled view of the exemplary embodiment, having the inner and outer cage components 2, 3 with the filter media 10 disposed there between and spaced so as to allow the requisite movement(s) described herein. In operation, the filtration cage assembly or cage assembly 11, shown assembled in FIG. 2, which is typical in size and shape as to fit into prior art filter compartments where particulate laden air is drawn into contact on the outside of the bag cage outer cage 3. The air is pulled thru the bag or filtration cage assembly 11. The air once filtered by filtration cage assembly 11 exits thru the hole of a bag cage flange 1. During this operation the filter medium that composes the sleeve and or bag of bag cage filter bag 10 will be motivated to be drawn into the center of the cage assembly 11 and the particulates will remain on the outer side of the filter membrane medium, or bag 10 relative to this flow. The operating position is further shown and described herein below as is an exemplary embodiment under a regenerative cycle whereby the normal air flow is reversed and a pulse or oscillation is provided.

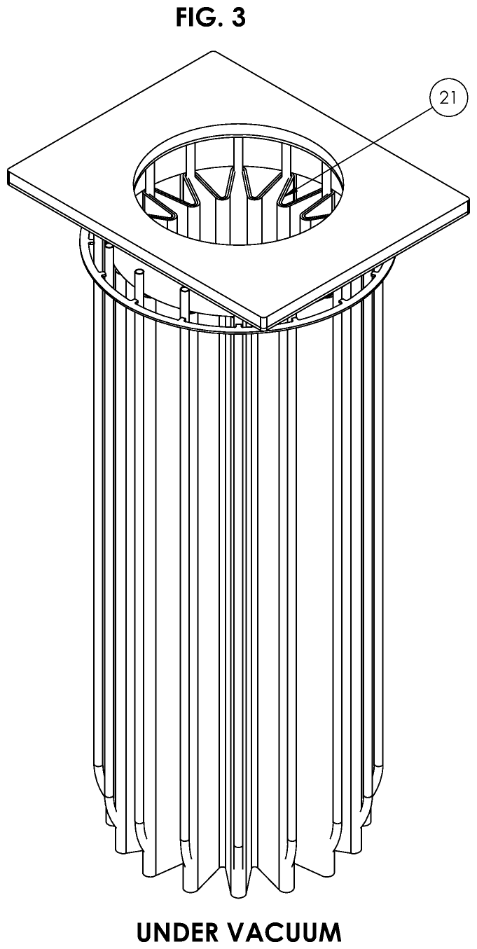

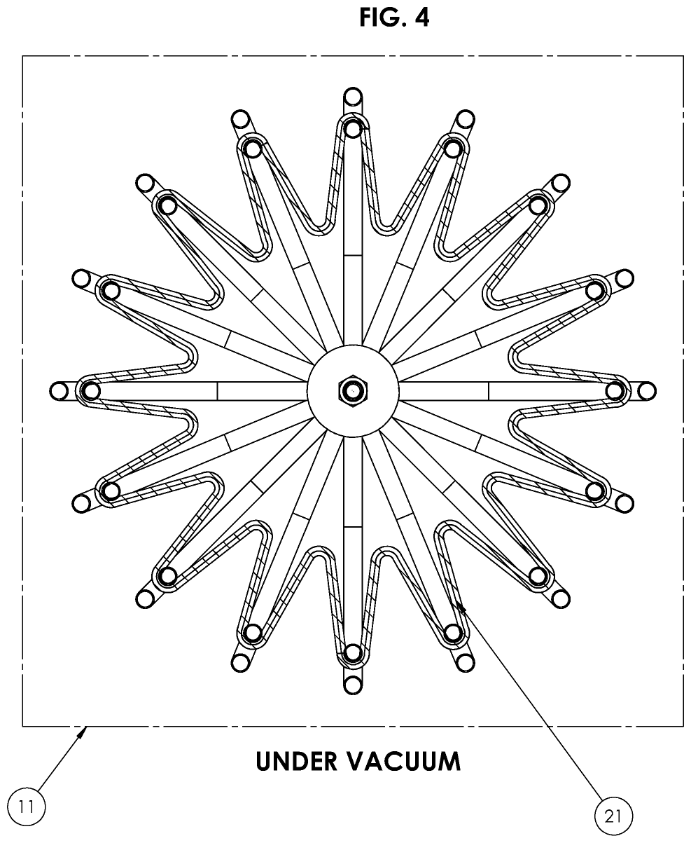

FIGS. 3 and 4 show the embodiment of FIG. 1 under vacuum, the suction forms the media around the inner cage component 2 and its cross-members. In FIGS. 3 and 4, the filter media 10 is shown restricted as to how far it will go into the cage center cavity by the retaining frame clamping surface 4 and the inner cage component 2. As best seen in FIGS. 3 and 4, the bag assembly 11 and/or the filter medium itself 10 will tend to make the filter media form pleats, inner facing pleats 21 on or between the frame rods or vertical cross-members 24 of the inner cage component 2. An example of this is shown in FIG. 3 as well as in the top view of FIG. 4 where the inner bag cage rods 24 can be seen as retaining the bag or filter media 10 to provide this “pleating” of the bag or filter media 10 to take place. This can be accentuated by existing pleats that can be present or pre-folded in the media 10. This pleating effect of the filter media 10 naturally occurs due to the action of the air drawn thru the filter media 10 and the change in pressure between the outer side and the inner side of the filter media 10 due to the action of a device commonly referred to as a blower (not shown) which draws particulate laden air thru the media 10 toward the flange 1 and the airflow exit in a first operating direction. Once this pleating of the media 10 has absorbed or filtered out substantial amounts of particulates such that they start to impede the flow of air or partially plug the flow of air thru the media 10 then a regenerative cycle will take place.

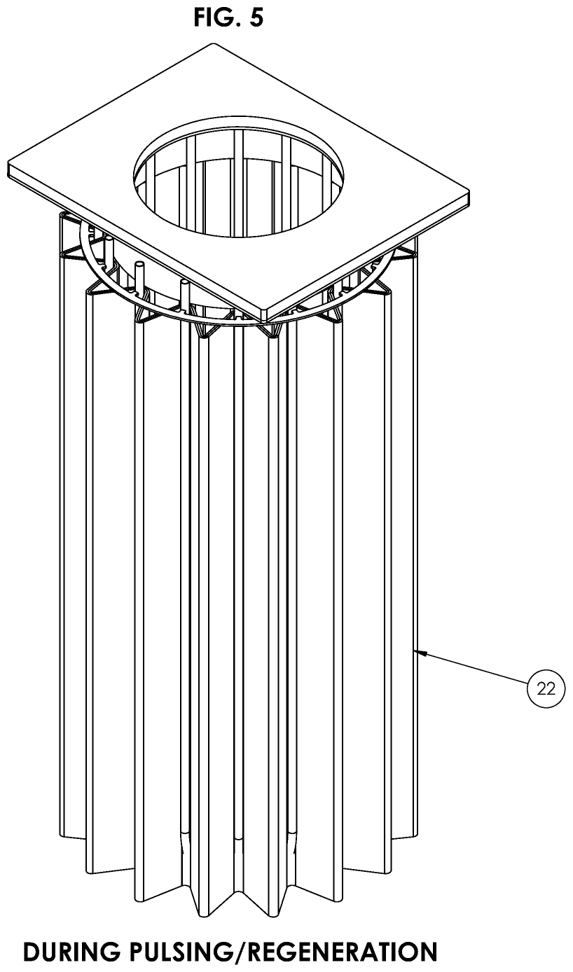

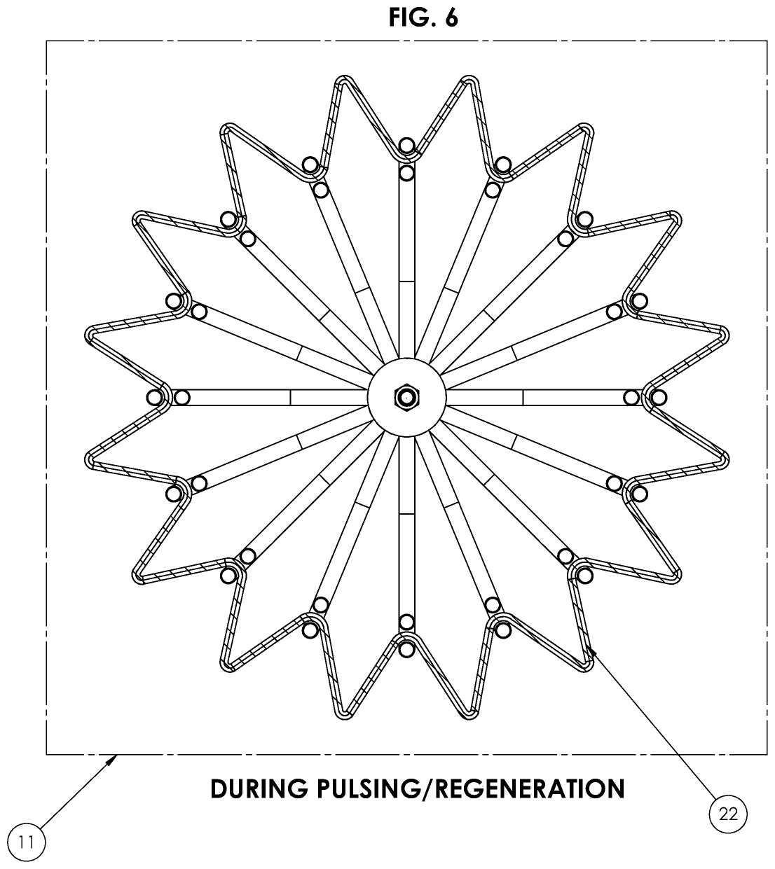

FIGS. 5 and 6 show the non-limiting exemplary embodiment of FIG. 1 during a regenerative cycle reversing the air flow and pulsing the air within the chamber whereby the media is reversed and forms around the outer cage component. This regenerative cycle can comprise pulses of air created above the filter media 10 which is strong or of significant volume and pressure so as to cause a greater air pressure in the opposite direction of the incoming air flow so as to temporarily reverse the airflow to be from the inside of the inner cage and therefore flow from the interior of the filter media 10 to the outside as opposed to from the outer surface of the media 10 to the inside. This representing an second operational direction of airflow used in the regenerative cycle. In this fashion the regenerative cycle with its pulse of air provides the motivation of the pleats in the media 10 to then flex in the opposite direction, as best shown FIGS. 5 and 6. The reversal of airflow will form outer facing pleats 22 facing in the opposite direction or the previous inner facing pleats 21 of FIGS. 3 and 4 and blasting the filter media with pulses of pressure motivating and even flexing the pleats abruptly in and out to create motion.

These pleats have multiple benefits in filtration and/or operational benefits in that they increase the amount of surface area available, as compared to an unpleated media, to remove particulates in the particulate laden air which can and/or helps or provides greater particulate removal and/or greater particulate removal between regenerative cycle operations where the removal and/or partial removal of particulate matter from the media 10 is carried out. In addition they can flex and reverse the shape such that caked on material is shaken or physically agitated.

The flexing and or direction change from having a pleat that will have “v” shape in one direction then changing to where the “v” shape is in the other direction as shown in the differences between FIGS. 3, 4 and FIGS. 5,6, makes it so that the materials that are typically stuck in the “wedge” of the “v” of the inside inner facing pleat 21 of the media 10, where materials can migrate into and are wedged or stacked, can be easily unpacked as the wedge is reversed. When motivated to reverse the inclination of the “v” shaped, towards those shown in the outer facing pleats of FIGS. 5 and 6, the previously wedge or “v” side is now fully exposed and the material or filter medium will actually open or go from being under compression to being expanded and so be more easily moved to release of said debris and particulate so that it can be better or more easily removed from the media surface 10.

The action of being pulsed by a burst of compressed air is much like the flapping or slapping or whipping motion that one uses to shake debris from a line hung area rug or carpet. The action tends to dislodge materials not only on the surface but also within the surface or partially in the body of the carpet or in this case the media 10. This effect is also beneficial to getting shingled or packed materials from the compressed surfaces of the bag cage bag filter medium 10. By variations in the flow and pressure such pulsing can achieve significant release and removal of the collected debris in the filter material 10.

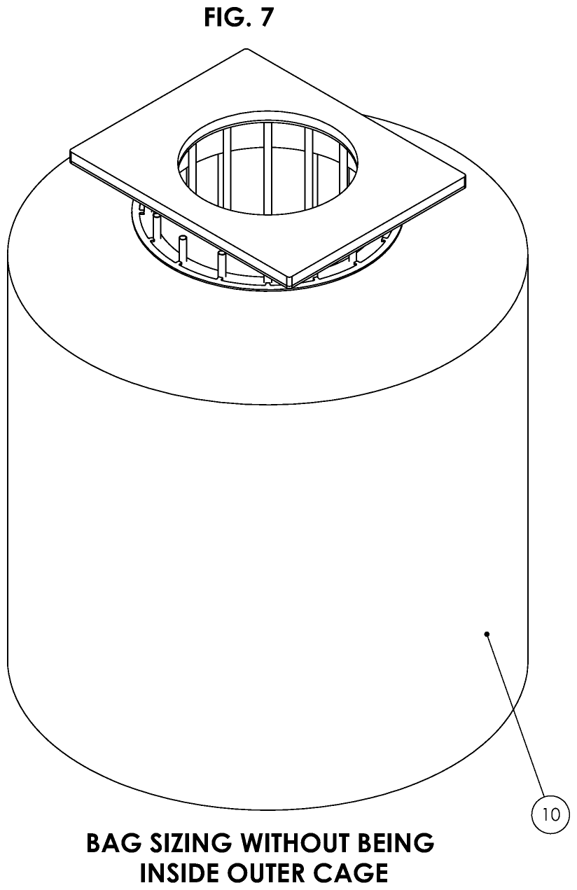

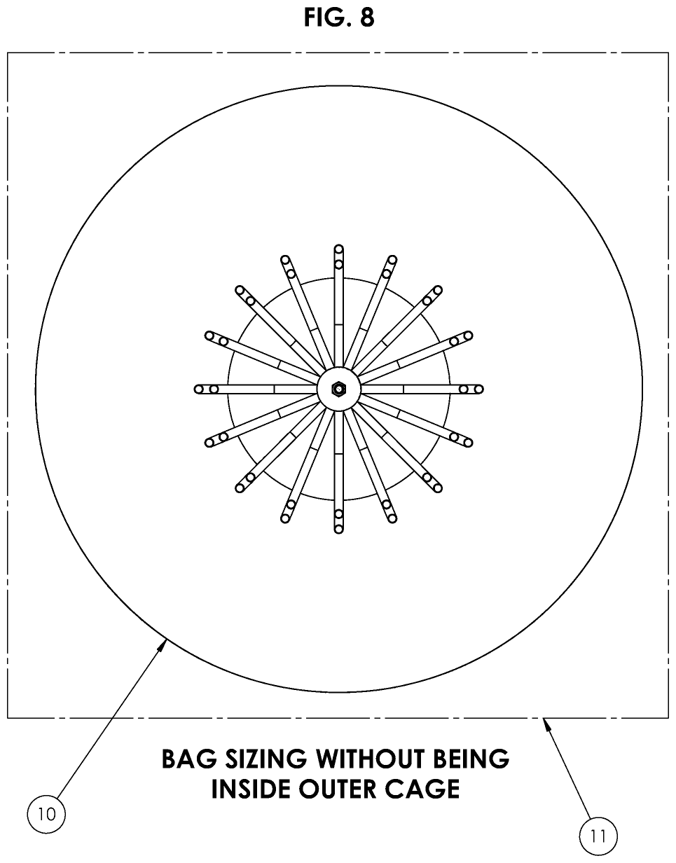

FIGS. 7 and 8 show a further non-limiting embodiment having an inner cage component but lacking the outer cage and having a bag like media component. This instant invention includes further exemplary embodiments where there would only be a singular cage and the bag or filter media would have anchor points on the bag or filter media surface that could attach to the singular/inner cage member 2 so as to retain the bag or filter media 10 so that the excess material of the bag will be suspended from the cage during operation but able to reverse in the curvature of the cloth or filter medium of the bag or filter media during a cleansing and or re-generating air pulse event. This singular cage non-limiting exemplary embodiment effectively does much the same thing as the previous non-limiting exemplary embodiment and does not depart from the basis of creating a system where filter media 10 is suspended in such a way as to provide significantly more filter surface area on the inner cage component 2 as well as a way to snap or create a mechanical action to reverse this direction and pleating.

The regenerating cycle with its pulse provides the added amount of mechanical cleaning action providing movement, preferably a rapid movement, that opens or flexes the filtration medium 10 position to a reversed position which can then flex the medium so that the filtering surface 10 goes from a state of more closed compression in the pleats of the inner cage component 2 pleating the filter medium 10 into the inward peak or inward facing pleats or “v” 21 to a reversed state. In this instance the reverse is a curved surface, like a blown up balloon, where the filtering medium 10 is more open to allow for air passing from the opposite side of the filter media 10 to dislodge and carry away debris and dust from the filter material 10 to collect in the collection area. This however does not provide as quick a pulsing action or permit pulsing as effectively as the prior non-limiting embodiment as the entire surface are of the bag or filter media 10 is moved over a much larger area.

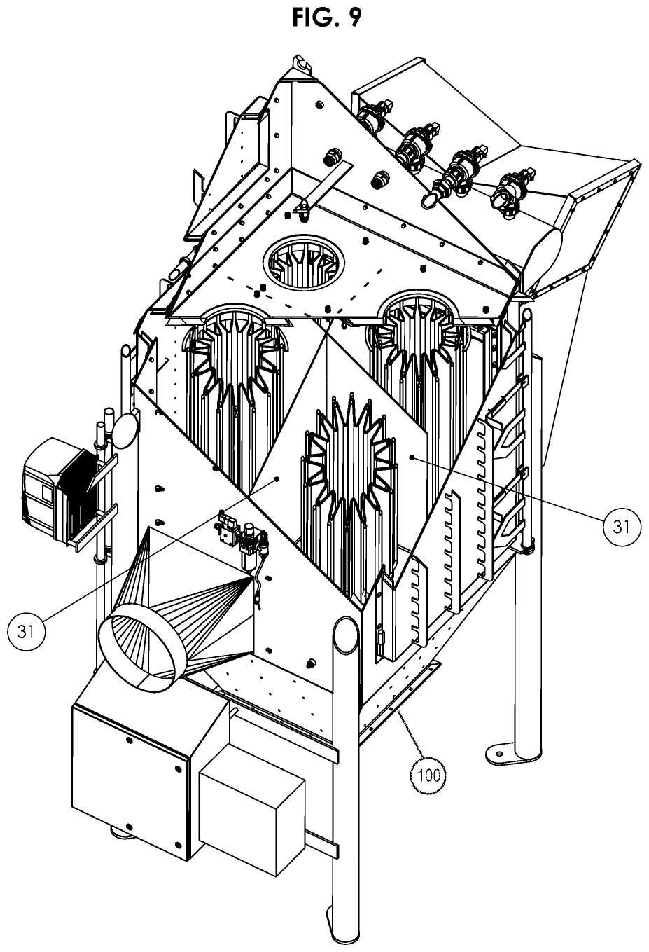

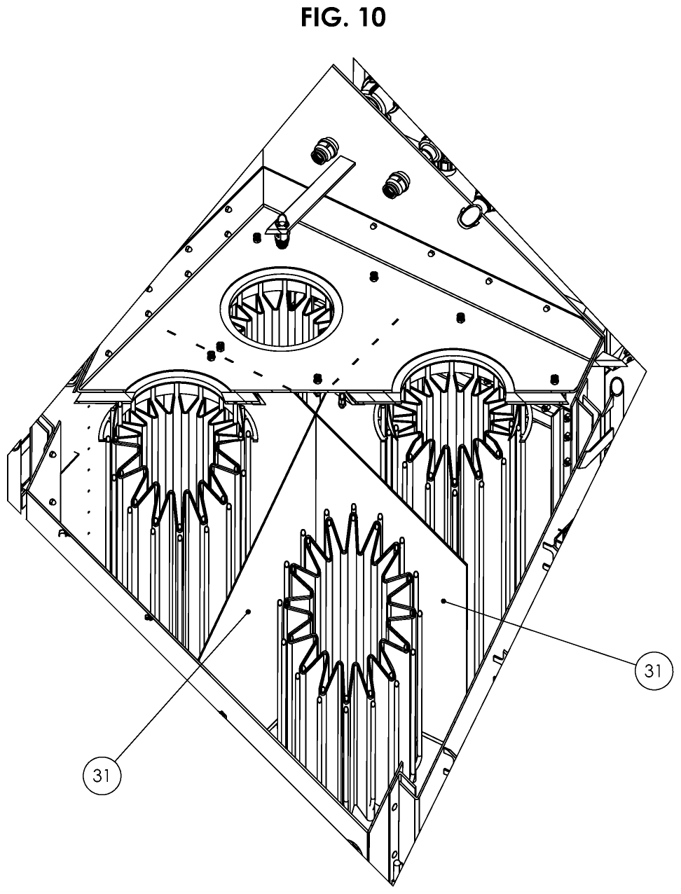

FIGS. 9 and 10 show cutaway views of an embodiment of the instant invention having multiple divided compartments. In a conventional dust and particulate mixture there can be provided a matrix of bags and/or filter assemblies 11 of the instant invention which are all being in operation so as to all have a significant load on them for filtering out the particles of incoming air. Such that when a regenerative cycle is commenced, air flow is briefly reversed and a regenerating pulse of air issued and the debris or particulate matter can be substantially re-circulated or the debris taken or particulate matter discharged from the surface of the filter media 10, reversed as previously described for a brief moment. If there was no blower in operation that continuously is drawing debris laden air into the cage assemblies 11, then when the regenerative pulse occurs then all of the debris that is dislodged from the bag cage bag would be able to just drop to the collection area below the assemblies 11 or into a collection container below the assemblies.

But since the blower is running at all times when the regenerative system pulse occurs, though some of the debris material will drop, but a portion will, rather than simply fall to the base of the collector in the collection area the debris or materials they, will instead be significantly motivated to just go to or be entrained by the air movement thru any or all of the adjacent cage assemblies 11. This lateral bias or movement bias or lateral movement of air and debris is because the adjacent bag cage assemblies are drawing debris/particulate material to them at a significant rate and when an adjacent filter regenerates any materials close to the regenerating filter will attract a significant amount of materials discharging from adjacent dust collection filters to them.

To reduce this lateral movement of discharging materials we have placed separators or divider plates 31 between each adjacent bag cage assembly 11 units so that materials being regeneratively discharged which are more of a mixture of larger and smaller particles in a clump or layer which will hold together and drop rather than be suspended in a dust cloud form and therefore go to the adjacent cage assembly 11. There is also a bit of a control factor of the regenerative cycle, where the regenerative process would comprise of an initial high pressure high volume blast or air so as to reverse the inner facing pleat 21 to an outer facing pleat 22 then a bit of additional time at a decreasing pressure and volume of air would cause the suspended or falling materials to continue to fall away from the bag cage assembly 11. Therefore on a system that regenerates with dividers 31 present, the debris discharged from the filter will tend to fall and not move laterally to the adjacent cage assembly 11.

The exemplary embodiment shown in FIGS. 9 and 10 provide a higher number of cage assemblies with greater amount of filter media 10 surface area to drop the air velocity going thru each cage filter assembly 11. Which allows for additional reduction in air flow which is what tends to keep finer particulates suspended in the moving air. The reasoning is that larger and greater quantities of filter material 10 and cage filter assemblies 11 will lower velocity thru effectively larger filters and will drop the air velocity and provide a better means for the collected debris to drop during a regenerative cycle.

It should also be noted that one experienced in the art will be able to make modifications to the non-limiting exemplary embodiments provided that do not change the intentions or means of how this invention operates so as to create a different device, nor a different device that has not and will not depart from the novelty of this described invention. Non-limiting examples can be, but are not limited to, different cage members, number of cage members or even how the inner and outer gages are located so as to locate and hold the position of the bag between the adjoining cages, and similar variations.

In the exemplary embodiments shown, the media to which the instant invention is being applied is food products and it must be totally cleanable. Any areas such as corners or crevices that cannot be readily accessed cannot be in the design. And if you have to disassemble to clean in there and have that carried out every night it becomes time consuming and prohibitive. For that reason a rectangular divider system is used so that when you open up the doors every surface is accessible in this exemplary embodiment.

Dividers are shown in the exemplary embodiment between the filter assembly units, which are provided by the debris passage panels or dividers to prevent debris from being re-circulated between the assemblies. The dividers or debris passage panels are meant to direct back wash or regenerative material dust and debris down and away towards the collection area rather than blow it from one filter to the side and onto other filters. The panels can also include additional dividers and/or baffles to modify airflow within the system or within in chamber in a favorable manner so as to slow down or speed up airflow and thereby promote the removal of debris to the collection area.

Each filter is in its own chamber in this exemplary embodiment, though variations in the design can include multiple filters per chamber as well. An exemplary embodiment is contemplated where the filter unit is placed into a cylindrical tube so as to provide for a uniform controlled path for the ducting of airflow and debris down. It should be understood that principal issue the dividers resolves is which can also be described as debris passage panels and that the separation and management of the debris both incoming and re-released is managed by the panels. The shape of the panels is a secondary tuning aspect. It would be understood by one skilled in the art that this debris passage panel has its utility in and of itself, and the optimal shape of such a passage is relative to design constraints such as size, volume, debris type, and the like. In the exemplary embodiment show, the debris passage panel is shown simply as square or rectangular, but the optimal shape can be modified to fit for a specific device, shape, application or the like. The panel is designed to maximize the separation of debris from the airflow and its removal down to the collection area 100. As indicated, the collection area can be at the base of the device and can be tapered. The collection area is easily accessible for removal and cleaning in the exemplary embodiment shown.

Though a cylindrical design can be used and is well within the spirit of this invention, for this application in the food products industry there would be corners that would have to be made round and that incurs extra formed sheet metal costs. In addition, the area between this formed sheet metal and the enclosure is not easily accessible and/or is harder to clean, more time consuming, and cleaning cannot always be fully done. In food product manufacture, if the material filtered from the production, such as buns and/or bread, if the filtered material sits it can become moldy and at that point cleaning with compressed air to dislodge materials can spread that mold. Thus consistent emptying and thorough cleaning is required. The exemplary embodiment shown is directed to use in such food product production, however, it is understood that it can be adapted for use in non-food related materials and processing.

The embodiments and examples discussed herein are non-limiting examples. The invention is described in detail with respect to preferred embodiments, and it will now be apparent from the foregoing to those skilled in the art that changes and modifications can be made without departing from the invention in its broader aspects, and the invention, therefore, as defined in the claims is intended to cover all such changes and modifications as fall within the true spirit of the invention.

What is claimed is:

1. A commercial baking air filtration system coupled to a commercial baking apparatus, the system comprising:
an external frame forming at least one chamber;
an at least one suction or blower device, the at least one suction or blower device creating at least two directions of air flow within the commercial baking air filtration system during operation;
an at least one controller controlling the at least one suction or blower device to operate to draw air in the at least two directions of air flow;
an at least one filter assembly having:
an at least two filter cages each having one or more filter support members, the first of the at least two cages surrounding and being spaced apart from the second of the at least two filter cages;
an at least one filter medium covering the second of the at least two filter cages and adapted to surround the second cage with sufficient filter material to allow the least one filter medium to deflect around the one or more filter support members in a first of an at least two directions of air flow and reverse direction away from the second of the at least two support cages and deflect around and into the first of the at least two filter cages between the one or more support members in a second of an at least two directions of airflow; and
an at least one collection area collecting debris from the filtration of air circulated from the baking apparatus and filtered by the commercial baking air filtration system.

2. The system of claim 1, wherein the first direction of airflow of the at least two directions of airflow is during a normal operation mode of the commercial baking air filtration system drawing in and filtering air from the baking apparatus.

3. The system of claim 1, wherein the second direction of airflow of the at least two directions of airflow is during a regeneration cycle operation mode of the commercial baking air filtration system.

4. The system of claim 3, wherein the controller is adapted to operate the blower in said regenerative cycle operation mode to reverse the direction of the at least one filter media to be drawn around and between the one or more support members of the first cage member of the at least two cage members and reduce pressure or pulse to flex or flap the at least one filter media to withdraw at least in part from around the one or more support members and then reapply pressure to again fully reverse the direction of the filter media to be drawn around and between the one or more support members.

5. The system of claim 1, wherein the one or more support members are arranged in the at least two cage members so that the at least one filter media is drawn in to form an at least one v-shaped pleat around the one or more support members of the at least two cage members in both of the at least two directions of airflow.

6. The system of claim 5, wherein the at least one pleat is formed in the direction of the first direction of the at least two directions of airflow in a normal operation mode.

7. The system of claim 6, wherein the at least one pleat is formed in the direction of the second direction of the at least two directions of airflow in a regenerative cycle operation mode.

8. The system of claim 7, wherein the at least one controller is adapted during the regenerative cycle operation mode to rapidly change or pulse pressure in the commercial baking filtration system and thereby create a flapping motion in the at least one filter material as between the two different directions of the at least one pleat, the flapping motion discharging debris captured in the at least one filter media.

9. The system of claim 1, wherein at least one filter media is bag shaped and adapted to fit over the first of the at least two cage.

10. The system of claim 1, wherein the at least one filter media is at least one of a cloth, paper, mesh, pre-pleated cloth, pre-pleated paper, and pre-pleated mesh.

11. The system of claim 1, wherein the at least one chamber further comprises multiple chambers for each of the at least one filter assembly.

12. The system of claim 1, further comprising an at least one filter collar on said at least one filter assembly, the at least one filter collar detachably retaining said at least one filter media during operation of the system.

13. The system of claim 12, the at least one filter assembly further comprising a cage formed from the first and second of the at least two cage members, a clamping surface, a cage assembly clamping disc, a cage stiffening ring secured to the second of the at least to cage components, a cage retaining device, a further cage retaining device, and a cage gasket collectively coupling the first and second of the at least two cage members to form the cage.

14. A commercial baking air filtration system coupled to a commercial baking apparatus, the system comprising:
an external frame forming at least one chamber;
an at least one suction or blower device, the suction or blower device creating at least one direction of air flow within the commercial baking air filtration system during operation;
an at least one controller controlling the at least one suction or blower device to operate to draw air in the at least two directions of air flow;
one or more filter assemblies having:
an at least one filter cage having one or more filter support members
an at least one filter medium covering the at least one filter cage adapted to surround the cage with sufficient filter material to allow the least one filter medium to deflect around the filter support members in a first of an at least two directions of air flow and reverse direction away from the support members in a second of an at least two directions of airflow; and
an at least one collection area collecting debris from the filtration of air circulated from the baking apparatus and filtered by the commercial baking air filtration system.

15. The system of claim 14, wherein an at least one pleat is formed in the direction of the first direction of the at least two directions of airflow in a normal operation mode.

16. The system of claim 15 wherein the at least one controller is adapted during the regenerative cycle operation mode to quickly change or pulse pressure in the commercial baking filtration system and thereby create a flapping motion in the at least one filter material as between the direction of the pleat and the second direction of the at least two directions of airflow, the flapping motion discharging debris captured in the at least one filter media.

17. The system of claim 16, wherein at least one filter media is bag shaped and adapted to form pleats about said at least one cage member and the one or more support members in the first of the at least to airflow directions and expand into a billowing bag shape that flaps in the second of the at least two airflow directions.

18. A method of operating a commercial baking air filtration system, the method comprising:
drawing in air from a commercial baking environment in an operating mode, said air having filterable debris;
passing the air in through an at least one frame having at least one filter chamber with at least one filter assembly, the at least one assembly having an at least one filter media;
drawing the at least one filter media over an at least one filter cage having one or more filter supports located in the at least one filter chamber;
filtering and collecting debris within the at least one filter media and the at least one filter chamber;
detecting when the operating efficiency of said at least one filter media is degraded from the filtering and collecting of debris;
initiating a regenerative cycle wherein the air being drawn in is reversed in direction and blown back into the filter chamber and the at least one filter media is reversed away from said at least one filter cage and one or more filter supports;
varying the pressure of the air reversed during the regenerative cycle to impart a flapping motion in said at least one filter media and thereby releasing the debris collected in the at least one filter media; and
collecting and disposing of the debris contained within the at least one filter chamber.

19. The method of claim 18, wherein the step of collecting and disposing the debris further comprises operating a door to release the collected debris from the at least one filter chamber.

20. The method of claim 19, wherein during the step of initiating a regenerative cycle and the reversal of the air the method further comprises the step of engaging a further at least one outer cage with the filter media and the step of varying the pressure further flexes the at least one filter media around one or more cage supports in the at least one out cage to impart the flapping motion.
